(19) United States
(12) Patent Application Publication
(10) Pub. No.: US 2014/0134370 A1
(43) Pub. Date: May 15, 2014

(54) POLYPROPYLENE HOMO-POLYMER BASED LAYERED FILM AND LAMINATE THEREOF

(71) Applicants: Chandrashekhar Ramchandra Abhyankar, Mumbai (IN); Mrinal Kanti Banjerjee, Mumbai (IN)

(72) Inventors: Chandrashekhar Ramchandra Abhyankar, Mumbai (IN); Mrinal Kanti Banjerjee, Mumbai (IN)

(73) Assignee: ESSEL PROPACK LTD., Mumbai (IN)

(21) Appl. No.: 14/126,040

(22) PCT Filed: Jun. 14, 2012
(86) PCT No.: PCT/IN2012/000422

§ 371 Date: Dec. 13, 2013

(30) Foreign Application Priority Data
Jun. 14, 2011 (IN) 1752/MUM/2011

(51) Int. Cl. B32B 27/08; B65D 65/40; B32B 27/32

(52) U.S. Cl. CPC B32B 27/08; B32B 27/32; B65D 65/40
USPC 428/36.6; 428/516; 428/213; 428/461; 428/476.9; 428/220; 428/354

(57) ABSTRACT

The present disclosure relates to a multilayered film comprising: an outer polyethylene layer; a core layer comprising 40% to 49% (w/w) of polypropylene homopolymer, 51% to 55% (w/w) of LLDPE, and 0% to 5% (w/w) of at least one additive; and an inner polyethylene layer. The multilayered film of the present disclosure exhibits good mechanical strength with lower thickness. The present disclosure also relates to a laminate comprising: an outer printing layer; a middle barrier layer; and an inner sealant layer; wherein at least one of the outer printing layer or the inner sealant layer is made up of a multilayered film comprising: an outer polyethylene layer; a core layer comprising 40% to 49% (w/w) of polypropylene homopolymer, 51% to 55% (w/w) of LLDPE, and 0% to 5% (w/w) of at least one additive; and an inner polyethylene layer. The present disclosure further relates to a laminated tube.

### TECHNICAL FIELD

The present disclosure relates to a polypropylene homopolymer based multilayered film, laminates thereof and a laminated tube with said laminate.

The polypropylene homopolymer based multilayered film exhibits good mechanical strength with lower thickness.

### BACKGROUND

Conventionally laminates are used in large quantities for the packaging and dispensing of various products, such as cosmetics and food products. The laminates are usually made of plastic polymers because of the inherent properties, such as physical properties of strength, light weight, durability, non-toxicity, resistance to light and heat, and inertness towards chemicals. Such properties make laminates an appropriate choice for application in packaging industry.

Generally, thickness of the laminates used in the packaging industry range from about 250 microns (μ) to 350 microns Further, the laminates of such thickness are employed in forming various storage containers such as tubes, for packaging and holding the products. The thickness of the laminate in conjunction with the inherent polymer structure provides mechanical strength and stiffness to the laminate for being used for making storage containers for various product applications.

Conventionally, polypropylene known to have high stiffness among the commodity polymer family like polyolefin and can impart stiffness and mechanical strength when used in the laminate. On the other hand, polypropylene exhibits poor binding property with other polyolefins and Aluminum foil etc. In certain conventional laminates, copolymers of polyethylene and polypropylene are used in the outer layer of the laminates to impart mechanical strength to the laminate and to overcome the poor binding property. However, thin laminates, such as the laminates having thicknesses less than 250 microns, produced using such copolymers generally lack mechanical strength and consistency in multilayer film thickness.

United States Patent Application US 2008/0299364 discloses a multilayer film containing at least three layers, two outer layers and a core layer, each outer layer independently having at least 50% wt of a single site catalyst produced LLDPE component having a density of less than 940 kg/m³ and preferably an LDPE component and the core layer containing at least 50% by weight polypropylene component and upto 50% by weight single site produced LLDPE component having a density of less than 940 kg/m³. The single site LLDPE used in US 2008/0299364 is a metallocene produced LLDPE, which imparts peculiar properties to the LLDPE produced. It is also disclosed in US 2008/0299364 that different catalyst used in the production of LLDPE gives different properties to the polymer produced. Thus, the multilayered film disclosed in US 2008/0299364, has a very limited use.

### SUMMARY

The present disclosure relates to a multilayered film comprising: an outer polyethylene layer; a core layer comprising 40% to 49% (w/w) of polypropylene homopolymer, 51% to 55% (w/w) of Liner Low Density Polyethylene (LLDPE), and 0% to 5% (w/w) of at least one additive; and an inner polyethylene layer.

The present disclosure further relates to a laminate comprising: an outer printing layer; a middle barrier layer; and an inner sealant layer; wherein at least one of the outer printing layer or the inner sealant layer is made up of a multilayered film comprising: an outer polyethylene layer; a core layer comprising 40% to 49% (w/w) of polypropylene homopolymer, 51% to 55% (w/w) of LLDPE, and 0% to 5% (w/w) of at least one additive.

The present disclosure also relates to a laminate tube made up of the laminate of the present disclosure.

These and other features, aspects, and advantages of the present disclosure will become better understood with reference to the following description and appended claims. This summary is provided to introduce a selection of concepts in a simplified form. This summary is not intended to identify key features or essential features of the claimed subject matter, nor is it intended to be used to limit the scope of the claimed subject matter.

### BRIEF DESCRIPTION OF THE DRAWINGS

The above and other features, aspects, and advantages of the present disclosure will be better understood with regard to the following description, appended claims, and accompanying drawings where:

FIG. 1 illustrates the polypropylene homo-polymer based multilayered film, according to an embodiment of the present subject matter.

FIG. 2 illustrates a laminate comprising the polypropylene homo-polymer based multilayered film, according to an embodiment of the present subject matter.

### DETAILED DESCRIPTION

The present disclosure provides a multilayered film comprising: an outer polyethylene layer; a core layer comprising 40% to 49% (w/w) of polypropylene homopolymer, 51% to 55% (w/w) of Liner Low Density Polyethylene (LLDPE), and 0% to 5% (w/w) of at least one additive; and an inner polyethylene layer.

According to the present disclosure the LLDPE used is preferably a non-Metallocene LLDPE, which is a normal Ziegler-Natta polymer and not a single site produced polymer.

An embodiment of the present disclosure provides a multilayer film comprising: an outer polyethylene layer; a core layer comprising 40% (w/w) of polypropylene homopolymer, 55% (w/w) of Liner Low Density Polyethylene (LLDPE), and 5% (w/w) of at least one additive; and an inner polyethylene layer.

Another embodiment of the present disclosure provides a multilayered film comprising: an outer polyethylene layer comprising: 70% to 90% (w/w) of Liner Low Density Polyethylene LLDPE; and 10% to 30% (w/w) of Low Density Polyethylene (LDPE); a core layer comprising 40% to 49% (w/w) of polypropylene homopolymer, 51% to 55% (w/w) of Liner Low Density Polyethylene (LLDPE), and 0% to 5% (w/w) of at least one additive; and an inner polyethylene layer.

Still, another embodiment of the present disclosure provides a multilayered film comprising: an outer polyethylene layer comprising: 80% (w/w) of Liner Low Density Polyethylene LLDPE; and 20% (w/w) of Low Density Polyethylene (LDPE); a core layer comprising 40% to 49% (w/w) of polypropylene homopolymer, 51% to 55% (w/w) of Liner Low Density Polyethylene (LLDPE), and 0% to 5% (w/w) of at least one additive; and an inner polyethylene layer.

Yet another embodiment of the present disclosure provides a multilayer film comprising: an outer polyethylene layer; a core layer comprising 40% to 49% (w/w) of polypropylene homopolymer, 51% to 55% (w/w) of Liner Low Density Polyethylene (LLDPE), and 0% to 5% (w/w) of at least one additive; and an inner polyethylene layer, comprising: 70% to 90% (w/w) of Liner Low Density Polyethylene LLDPE; and 10% to 30% (w/w) of Low Density Polyethylene (LDPE).

Further, an embodiment of the present disclosure provides a multilayer film comprising: an outer polyethylene layer; a core layer comprising 40% to 49% (w/w) of polypropylene homopolymer, 51% to 55% (w/w) of Liner Low Density Polyethylene (LLDPE), and 0% to 5% (w/w) of at least one additive; and an inner polyethylene layer, comprising: 80% (w/w) of Liner Low Density Polyethylene LLDPE; and 20% (w/w) of Low Density Polyethylene (LDPE).

Another embodiment of the present disclosure provides a multilayered film comprising: an outer polyethylene layer comprising: 70% to 90% (w/w) of Liner Low Density Polyethylene LLDPE; and 10% to 30% (w/w) of Low Density Polyethylene (LDPE).; a core layer comprising 40% to 49% (w/w) of polypropylene homopolymer, 51% to 55% (w/w) of Liner Low Density Polyethylene (LLDPE), and 0% to 5% (w/w) of at least one additive; and an inner polyethylene layer, comprising: 70% to 90% (w/w) of Liner Low Density Polyethylene LLDPE; and 10% to 30% (w/w) of Low Density Polyethylene (LDPE).

Still, another embodiment of the present disclosure provides a multilayered film comprising: an outer polyethylene layer comprising: 80% (w/w) of Liner Low Density Polyethylene LLDPE; and 20% (w/w) of Low Density Polyethylene (LDPE).; a core layer comprising 40% to 49% (w/w) of polypropylene homopolymer, 51% to 55% (w/w) of Liner Low Density Polyethylene (LLDPE), and 0% to 5% (w/w) of at least one additive; and an inner polyethylene layer, comprising: 80% (w/w) of Liner Low Density Polyethylene LLDPE; and 20% (w/w) of Low Density Polyethylene (LDPE).

Further an embodiment of the present disclosure provides a multilayered film comprising: an outer polyethylene layer comprising: 80% (w/w) of Liner Low Density Polyethylene LLDPE; and 20% (w/w) of Low Density Polyethylene (LDPE).; a core layer comprising 40% (w/w) of polypropylene homopolymer, 55% (w/w) of Liner Low Density Polyethylene (LLDPE), and 5% (w/w) of at least one additive; and an inner polyethylene layer, comprising: 80% (w/w) of Liner Low Density Polyethylene LLDPE; and 20% (w/w) of Low Density Polyethylene (LDPE).

The Linear Low Density Polyethylene (LLDPE) used in the present disclosure is a polymer which can be selected from but not limited to C6 (which is hexane based LLDPE) such as Dow's “2645 G” and C8 (which is Octane based LLDPES) such as Dow's “5056 G”, “2045”, “2038”, “2740” Grades. Other non limiting examples are metallocene polyethylene polymer such as Exxon Mobil's “Exceed” family (such as “1018 CA”, “1327 CA”), “Enable 3505” polymers from metallocene grades, Dow's “Elite” grade Metallocene LLDPE family. The similar Octane or Hexane based LLDPE polymer grades from other polymer manufacturers, such as Mitsui Chemicals' C6 (Octane based LLDPE)—Ulzex grade or (hexane based) metallocene 4020 L Evolue grades etc. also can be used. Ulzex & Dow Octane and hexane based polymers as mentioned above are non-metallocene polymers, which are normal Ziegler-Natta polymers (not a single site Polymers) and are preferably used to produce the polypropylene homopolymer based laminates.

LDPE in accordance with the present invention has a density of around 0.918 g/cc to 0.935 g/cc, preferably 0.933 gm/cc. The density of the LLDPE can range from about 0.918 g/cc to 0.940 g/cc. In one example, the density of LLDPE is about 927 gm/cc. In one example, the LLDPE used in the polypropylene homopolymer based laminate of the present disclosure is “Exceed 1327CA™” by ExxonMobil™ and the LDPE can be BW™ by ExxonMobil™, which are both commercially available polymers.

The additive in accordance with the present disclosure is one of the general additives known in the pertinent art to modify the properties of the polymer. Such additives can be stabilizers, antioxidants, modifiers, color pigments or colorants, etc. the additive in accordance with the present invention is preferably a color pigment. Notably commercial colorant additives such as black master batches, white master batches, pink master batches and other color master batches can be used.

The polypropylene homopolymer used in the present disclosure can be a notably commercially available such as Borealis “Borpact 918 CF”, Exxone Mobil, Basel HP “Moplene 1073”.

In an embodiment of the present disclosure the multilayered film of the present disclosure has a thickness of the outer polyethylene layer, the core layer and the inner polyethylene layer is in a ratio range of 1:1:1 to 1:2:1. More preferably, the thickness of the outer polyethylene layer, the core layer and the inner polyethylene layer is in the ratio of 1:1:1 or 1:2:1.

The thickness of the multilayered film of the present disclosure is in the range of 90μ to 120μ, when incorporated in a laminate as an outer print Layer film and 40μ to 70μ when incorporated in the laminate as a inner sealant/product contact layer film.

The multilayered film of the present disclosure provides desired mechanical strength with lower thickness when compared to conventional layered film with copolymers of polyethylene and Polypropylene or HDPE.

The present disclosure further provides a laminate comprising: an outer printing layer;

a middle barrier layer; and an inner sealant layer; wherein at least one of the outer printing layer or the inner sealant layer is made up of a multilayered film comprising: an outer polyethylene layer; a core layer comprising 40% to 49% (w/w) of polypropylene homopolymer, 51% to 55% (w/w) of LLDPE, and 0% to 5% (w/w) of at least one additive; and an inner polyethylene layer.

An embodiment of the present disclosure provides a laminate comprising: an outer printing layer; a middle barrier layer; and an inner sealant layer; wherein at least one of the outer printing layer or the inner sealant layer is made up of a multilayered film comprising: an outer polyethylene layer; a core layer comprising 40% (w/w) of polypropylene homopolymer, 55% (w/w) of LLDPE, and 5% (w/w) of at least one additive; and an inner polyethylene layer.

Further embodiment of the present disclosure provides a laminate comprising: an outer printing layer; a middle barrier layer; and an inner sealant layer; wherein at least one of the outer printing layer or the inner sealant layer is made up of a multilayered film comprising: an outer polyethylene layer comprising of: 70% to 90% (w/w) of Liner Low Density Polyethylene LLDPE; and 10% to 30% (w/w) of Low Density Polyethylene (LDPE); a core layer comprising 40% to 49% (w/w) of polypropylene homopolymer, 51% to 55% (w/w) of LLDPE, and 0% to 5% (w/w) of at least one additive; and an inner polyethylene layer.

Yet, another embodiment of the present disclosure provides a laminate comprising: an outer printing layer; a middle barrier layer; and an inner sealant layer; wherein at least one of the outer printing layer or the inner sealant layer is made up of a multilayered film comprising: an outer polyethylene layer; a core layer comprising 40% to 49% (w/w) of polypropylene homopolymer, 51% to 55% (w/w) of LLDPE, and 0% to 5% (w/w) of at least one additive; and an inner polyethylene layer comprising of: 70% to 90% (w/w) of Liner Low Density Polyethylene LLDPE; and 10% to 30% (w/w) of Low Density Polyethylene (LDPE).

Further an embodiment of the present disclosure provides a laminate comprising: an outer printing layer; a middle barrier layer; and an inner sealant layer; wherein at least one of the outer printing layer or the inner sealant layer is made up of a multilayered film comprising: an outer polyethylene layer comprising of: 70% to 90% (w/w) of Liner Low Density Polyethylene LLDPE; and 10% to 30% (w/w) of Low Density Polyethylene (LDPE); a core layer comprising 40% to 49% (w/w) of polypropylene homopolymer, 51% to 55% (w/w) of LLDPE, and 0% to 5% (w/w) of at least one additive; and an inner polyethylene layer comprising of: 70% to 90% (w/w) of Liner Low Density Polyethylene LLDPE; and 10% to 30% (w/w) of Low Density Polyethylene (LDPE).

Still, another embodiment of the present disclosure provides a laminate comprising: an outer printing layer; a middle barrier layer; and an inner sealant layer; wherein at least one of the outer printing layer or the inner sealant layer is made up of a multilayered film comprising: an outer polyethylene layer comprising of: 80% (w/w) of Liner Low Density Polyethylene LLDPE; and 20% (w/w) of Low Density Polyethylene (LDPE); a core layer comprising 40% (w/w) of polypropylene homopolymer, 55% (w/w) of LLDPE, and 5% (w/w) of at least one additive; and an inner polyethylene layer comprising of: 80% (w/w) of Liner Low Density Polyethylene LLDPE; and 20% (w/w) of Low Density Polyethylene (LDPE).

Yet another embodiment of the present disclosure provides a laminate comprising: an outer printing layer made up of a multilayered film comprising: an outer polyethylene layer; a core layer comprising 40% to 49% (w/w) of polypropylene homopolymer, 51% to 55% (w/w) of LLDPE, and 0% to 5% (w/w) of at least one additive; and an inner polyethylene layer; a middle barrier layer; a first tie layer binding the outer printing layer and the middle barrier layer; an inner sealant layer made up of a polyethylene; and a second tie layer binding the inner sealant layer and the middle barrier layer.

Still, another embodiment of the present disclosure provides a laminate comprising: an outer printing layer made up of a polyethylene; a middle barrier layer; a first tie layer binding the outer printing layer and the middle barrier layer; an inner sealant layer made up of a multilayered film comprising: an outer polyethylene layer; a core layer comprising 40% to 49% (w/w) of polypropylene homopolymer, 51% to 55% (w/w) of LLDPE, and 0% to 5% (w/w) of at least one additive; and an inner polyethylene layer; and a second tie layer binding the inner sealant layer and the middle barrier layer.

Yet another embodiment of the present disclosure provides a laminate comprising: an outer printing layer made up of a multilayered film comprising: an outer polyethylene layer; a core layer comprising 40% to 49% (w/w) of polypropylene homopolymer, 51% to 55% (w/w) of LLDPE, and 0% to 5% (w/w) of at least one additive; and an inner polyethylene layer; a middle barrier layer; a first tie layer binding the outer printing layer and the middle barrier layer; an inner sealant layer made up of a multilayered film comprising: an outer polyethylene layer; a core layer comprising 40% to 49% (w/w) of polypropylene homopolymer, 51% to 55% (w/w) of LLDPE, and 0% to 5% (w/w) of at least one additive; and an inner polyethylene layer; and a second tie layer binding the inner sealant layer and the middle barrier layer.

The middle barrier layer of the laminate of the present disclosure is usually formed of a material selected from but not limited to aluminum foil, ethyl vinyl hydroxide (EVOH) film or Nylon based, film, and serves as a barrier layer to atmospheric air, oxygen and moisture.

The laminate of the present disclosure has a thickness in the range of 175 microns (μ) to 220 microns (μ). Conventionally, a desired mechanical strength is achieved by a polyethylene based laminate or a high density polyethylene based laminate when the thickness of the laminate is in the range of 280-350 microns. As aforementioned, the multilayered film, of the present disclosure, when used in a laminate structure, facilitate in reducing the thickness of the laminate by 30% to 40%, preferably 30%-35% without compromising on the mechanical strength of the laminate.

Laminates are made of various layers of films bonded together either by fusing or by using an adhesive. Generally, the laminates are formed as three layers namely an outer layer, a middle layer, and an inner layer, having a tie layer each between the outer layer and the middle layer and between the middle layer and the inner layer. The outer layer usually serves as the printing layer and is composed mainly of polyethylene. The inner layer of the laminate serves as the sealant layer. When the laminate has been processed and formed into a storage container, the inner layer prevents contact between contents packaged in the storage container and the middle layer. The tie layer between the different layers serves as an adhesive to bind the layers together and form the laminate.

Conventional laminates have a thickness ranging from about 250 microns to 300 microns. The polyethylene present in the outer layer and the inner layer impart mechanical strength and stiffness to the laminate by virtue of the inherent polymer structures. Recently, to add to the aesthetic appeal of the laminates with cost effectiveness, a sharp increase in the demand for thin, yet durable laminates has been witnessed. However, a decrease in the thickness of the laminate having polyethylene in the outer and the inner layers of the laminate adversely affects mechanical properties, such as stiffness, of the laminate and resilience properties in the tube containers.

The core layer of polypropylene homopolymer, in the polypropylene homopolymer based multilayered film of the present disclosure, imparts mechanical strength and stiffness to the laminate. The use of polyethylene in the skin layers of the outer layer allows easy binding of the various layers of the laminate and also allows for convenient binding and sealing of the laminate when storage containers are produced using the laminate. Further, the use of the polypropylene homopolymer imparts high mechanical strength with reduced overall thickness of the laminate. In one embodiment polypropylene homopolymer based laminates can have a thickness ranging between about 175 microns and 220 microns and exhibit mechanical strength comparable to conventional laminates of thickness ranging between about 250 microns and 300 microns.

The present disclosure also provides a laminate tube made up of a laminate of the present disclosure.

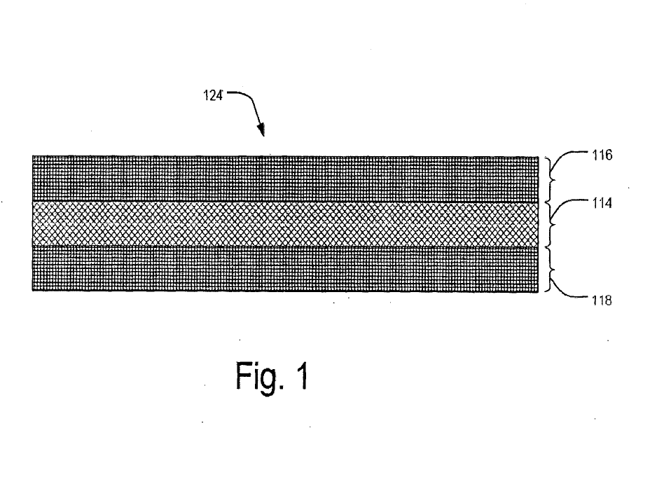

FIG. 1 illustrates an exemplary structure of the polypropylene homopolymer based multilayered layered film 124, in accordance with an embodiment of the present subject matter. In said embodiment, as mentioned earlier, the polypropylene homopolymer based layered film 124 is formed having a three-layered structure. The core layer 114 comprises of 40%-49% (w/w) of polypropylene homopolymer, 51%-55% (w/w) of LLDPE and 0% to 5% (w/w) of at least one additive. The outer layer 116 and the inner layer 118 are polyethylene layers comprising 70% to 90% (w/w) of LLDPE and 10% to 30% LDPE.

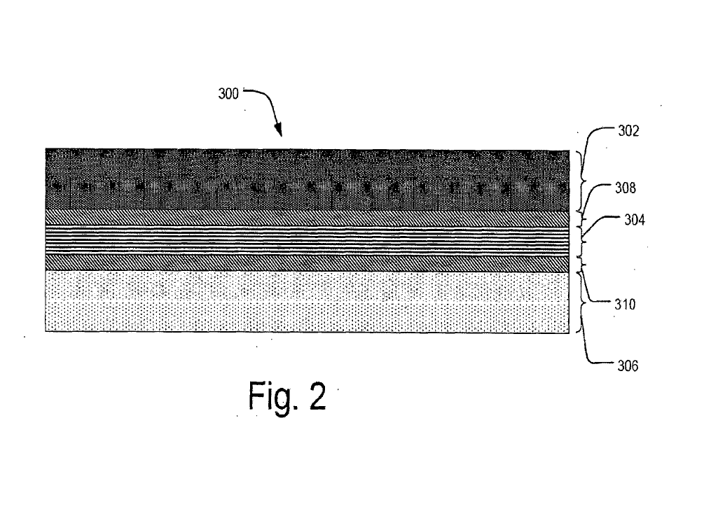

FIG. 2 illustrates an exemplary structure of the laminate 300 comprising the polypropylene homopolymer based multilayered film 124. In an embodiment, the thickness of the laminate 300 ranges from about 180 microns to about 200 microns. Further, as a result of the presence of the polypropylene homopolymer based multilayered film 124, in the laminate 300, the mechanical strength and stiffness of the laminate is high.

The laminate comprising polypropylene homopolymer based Five layer Laminate 300 has an outer printing layer 302, which serves as the printing layer. In an embodiment, the outer printing layer 302 is formed by the polypropylene homopolymer based multilayered film 124. Further, the laminate 300 have a middle barrier layer 304, which is a barrier layer. In an embodiment, the middle barrier layer 304 can be an aluminium barrier layer, which obstructs the passage of atmospheric gases and moisture through the laminate 300. In another embodiment, middle barrier layer 304 can be an ethyl vinyl hydroxide (EVOH) polymer layer, which provides a barrier to atmospheric gases and moisture and also exhibits aroma preserving properties.

Further, the inner sealant layer 306, of the laminate 300, is the layer that comes in direct contact with contents when the laminate 300 is formed into a storage container, such as a tube.

In an embodiment, the polypropylene homopolymer based multilayered film 124 can be employed to serve as the inner layer of the -laminate 300. In another embodiment, the inner sealant layer 306 can be composed mainly of polyethylene.

The outer printing layer 302 and the middle barrier layer 304 is bonded together using a first adhesive layer or a tie layer 308; and in a similar manner, the middle barrier layer 304 is bonded to the inner sealant layer 306 using a second adhesive layer or tie layer 310. As a result of bonding of the different layers, the laminate 300 is obtained.

In accordance with the present disclosure, the tie layers comprises of layers that generally binds the barrier layer to the outer printing layer and the inner sealant layer in the laminate. Depending on the type of the barrier layer, the tie layer can be any tie layer that is suitable for the said bonding.

Although the above description is provided with reference to the polypropylene homopolymer based multilayered film 124 being either used in the outer printing layer 302 or the inner sealant layer 306 of the laminate 300 it will be understood that the polypropylene homopolymer based multilayered film 124 can be present in any one of the layers 302, or 306, or in both the layers.

In one of the embodiment, the polyethylene homopolymer based laminate is prepared by a Blown Film Process. Blown film extrusion is a technology that is the most common method for making plastic films, especially for the packaging industry. The process involves extruding a tube of molten polymer through a die and inflating to several times its initial diameter to form a thin film bubble. This bubble is then collapsed and used as a lay-flat film or can be made into bags. Usually polyethylene is used with this process, and other materials can be used as blends with these polymers in production of multilayer blown films.

Typically, blown film extrusion is carried out vertically upwards. This procedure consists of four main steps:
1. The polymer material is taken in a pellet form, which are successively compacted and melted to form a continuous, viscous liquid. This molten plastic is then forced, or extruded, through an annular die.
2. Air is injected through a hole in the center of the die and the pressure causes the extruded melt to expand into a bubble. The air entering the bubble replaces air leaving it, so that even and constant pressure is maintained to ensure uniform thickness of the film.
3. The bubble is pulled continually upwards from the die and a cooling ring blows air onto the film. The film can also be cooled from the inside using internal bubble cooling. This reduces the temperature inside the bubble, while maintaining the bubble diameter.
4. After solidification at the frost line, the film moves into a set of nip rollers which collapse the bubble and flatten it into two flat film layers. The puller rolls pull the film onto windup rollers. The film passes through idler rolls during this process to ensure that there is uniform tension in the film. Between the nip rollers and the windup rollers, the film may pass through a treatment centre, depending on the application. During this stage, the film may be slit to form one or two films, or surface treated

In an embodiment, the laminated tube, in accordance with the present disclosure is manufactured by using the laminate feed stock that is simply a poly-foil-poly structure that has polyethylene on either side of a thin gauge of foil. Some laminate structures also incorporate paper. The most popular way of decorating the laminate feedstock material is by either letterpress or rotogravure printing. Rotogravure printing is used extensively to provide a high quality print buried within the laminate structure. Letterpress printing is used to decorate the surface of the laminate feedstock just prior to tubing that is ideal for added flexibility or smaller quantities.

The laminate tubes are formed by placing the rolls of laminate material onto the needles of the machine. The material is then taken in a flat state and fed through the forming rolls, which very gently turn the tube and form it into a cylinder of variable size depending on the customer's needs. Heat generated by high frequency fuses the sides of the material together to form a solid cylindrical tube. After the tube has been formed, it goes to the cutting station that slices it into various lengths.

After the tube has been formed into the desired cylindrical shape and length, the tube is transferred to the heading operation. As with plastic tubes, several heading methodologies are available. One particular method uses a preformed head. The tube is then placed onto a mandrel, the preformed head and shoulder are fed down vibrator shoots and fused to the top of the tube by means of heat generated by high frequency energy. Other methodologies apply the head to the sleeve in a similar manner to plastic tubes—either by injection or compression molding whereby heat fuses the head to the tube body.

After the complete tube has been formed, it goes to the capping station. The cap flat style, fez style or pedestal style is chosen based on the customer's needs. The cap is applied and torqued to the desired torquing requirements. The tube is then ejected onto a conveyor and taken to a packing operation where it is packed into a carton and is ready for the customer.

### EXAMPLES

The following examples are given by way of illustration of the present invention and should not be construed to limit the scope of present disclosure. It is to be understood that both the foregoing general description and the following detailed description are exemplary and explanatory only and are intended to provide further explanation of the claimed subject matter.

### Example 1

Compacting and melting a multilayer film comprising an outer polyethylene layer containing linear low density polyethylene in an amount of 70% (w/w) and low density polyethylene in an amount of 30% (w/w); a core layer containing a polypropylene homopolymer in an amount in the range of 40% (w/w), a linear low density polyethylene in an amount in the range of 55% (w/w), and black color master batch in amount of 5% (w/w); and an inner polyethylene layer containing linear low density polyethylene in an amount of 70% (w/w) and low density polyethylene in an amount in the range of 30% (w/w) to obtain a compacted and melted multilayered film. This multilayered film is then extruded through an annular die to obtain an extruded multilayered film. Then injecting air through a hole in the centre of the annular die to obtain a bubble shaped multilayered film, followed by cooling the bubble shaped multilayered film using air to obtain a cooled bubble shaped multilayered film, moving the cooled bubble shaped multilayered film into a set of nip rollers which collapse the cooled bubble shaped multilayered film and flatten it to obtain two flat multilayered film layers. Then pulling each multilayered film layer using the puller onto windup rollers, passing the multilayered film layer through idler rolls to obtain the multi-layered laminate.

### Example 2

The mechanical strength of the laminate of the present disclosure having thickness of 222μ is compared with the conventional laminates comprising PE having thickness in the range of 275μ to 250μ. The results obtained are shown in table 1 below:

TABLE 1

| | | | | Present Disclosure |
|---|---|---|---|---|
| | | Comparative-I | Comparative-II | 222μ Total |
| | | 275μ Total | 252μ Total | thicknees/12μ Al |
| LAMINATE | | thicknees/12μ | thicknees/12μ Al | foil-HOMO |
| PROPERTIES | Unit | Al foil-PE based | foil-PE Based | Polymer PP Based |
| G.S.M. | — | 291.30 | 270.00 | 235.00 |
| THICKNESS | Mic. | 275 | 252 | 222 |
| b)INSTRON | Kg/80 mm | | | |
| (TEAR | | | | |
| STRENGTH) | | | | |
| MD | | 3.97 | 2.20 | 5.50 |
| TD | | 4.50 | 4.80 | 5.00 |
| COF | — | | | |
| INSIDE/METAL | | 0.25 | 0.27 | 0.26 |
| OUTSIDE/METAL | | 0.28 | 0.30 | 0.23 |
| STIFFNESS | mg | | | |
| MD | | 583.84 | 632.00 | 546 |
| TD | | 679.28 | 699.00 | 577 |
| ILBS | Kg/15 mm | | | |
| WPE/EAA | | cns | 1.100 | 0.910 |
| EAA/FOIL | | 0.500 | 0.592 | CNS |
| FOIL/EAA | | 1.701 | CNS | CNS |
| EAA/NPE | | 1.66 | 0.89 | 0.85 |

It can be concluded from Table 1 that though the thickness of polypropylene homopolymer based laminate is 222μ as compare to the thickness of PE based laminates having thickness 275μ and 252μ, the mechanical properties of polypropylene homopolymer based laminate of the present disclosure is better than the conventional laminates. Further, the polypropylene homopolymer based laminates of the present disclosure allows the reduction in the thickness of laminate from 275μ/252μ to about 222μ.

Although the subject matter has been described in considerable detail with reference to certain embodiments thereof, other embodiments are possible. As such, the spirit and scope of the invention should not be limited to the description of the embodiment contained herein.

1. A multilayered film comprising:
an outer polyethylene layer;
a core layer comprising 40% to 49% (w/w) of polypropylene homopolymer, 51% to 55% (w/w) of Liner Low Density Polyethylene (LLDPE), and 0% to 5% (w/w) of at least one additive; and
an inner polyethylene layer.

2. The multilayered film as claimed in claim 1, wherein the outer polyethylene layer and the inner polyethylene layer each independently comprises of:
70% to 90% (w/w) of a Liner Low Density Polyethylene LLDPE; and
10% to 30% (w/w) of a Low Density Polyethylene (LDPE).

3. The multilayered film as claimed in claim 1, wherein the core layer comprises 40% (w/w) of a polypropylene homopolymer, 55% (w/w) of LLDPE, and 5% (w/w) of at least one additive.

4. The multilayered film as claimed in claim 1, wherein the additive is selected from stabilizers, antioxidants, modifiers or color pigments.

5. The multilayered film as claimed in claim 4, wherein the color pigment is selected from black master batch, white master batch or pink color master batch.

6. The multilayered film as claimed in claim 1, wherein the outer polyethylene layer, the core layer and the inner polyethylene layer has a thickness in the ratio of 1:1:1 or 1:2:1.

7. A laminate comprising:
an outer printing layer;
a middle barrier layer; and
an inner sealant layer;
wherein at least the outer printing layer or the inner sealant layer is made up of a multilayered film comprising:
an outer polyethylene layer;
a core layer comprising 40% to 49% (w/w) of polypropylene homopolymer, 51% to 55% (w/w) of LLDPE, and 0% to 5% (w/w) of at least one additive; and
an inner polyethylene layer.

8. The laminate as claimed in claim 7, wherein the middle barrier layer is made up of a material selected from aluminium foil, ethyl vinyl hydroxide (EVOH) film or nylon based film.

9. The laminate as claimed in claim 7, wherein the outer polyethylene layer and the inner polyethylene layer are each independently comprising of:
70% to 90% (w/w) of Liner Low Density Polyethylene LLDPE; and
10% to 30% (w/w) of Low Density Polyethylene (LDPE).

10. The laminate as claimed in claim 7, wherein the laminate has thickness in the range of 180 microns to 200 microns.

11. The laminate as claimed in claim 7, comprising:
an outer printing layer made up of a multilayered film comprising: an outer polyethylene layer; a core layer comprising 40% to 49% (w/w) of polypropylene homopolymer, 51% to 55% (w/w) of LLDPE, and 0% to 5% (w/w) of at least one additive; and an inner polyethylene layer;
a middle barrier layer;
a first tie layer binding the outer printing layer and the middle barrier layer;
an inner sealant layer made up of a polyethylene; and
a second tie layer binding the inner sealant layer and the middle barrier layer.

12. The laminate as claimed in claim 7, comprising:
an outer printing layer made up of a polyethylene;
a middle barrier layer;
a first tie layer binding the outer printing layer and the middle barrier layer;
an inner sealant layer made up of a multilayered film comprising: an outer polyethylene layer; a core layer comprising 40% to 49% (w/w) of polypropylene homopolymer, 51% to 55% (w/w) of LLDPE, and 0% to 5% (w/w) of at least one additive; and an inner polyethylene layer; and
a second tie layer binding the inner sealant layer and the middle barrier layer.

13. The laminate as claimed in claim 7, comprising:
an outer printing layer made up of a multilayered film comprising: an outer polyethylene layer; a core layer comprising 40% to 49% (w/w) of polypropylene homopolymer, 51% to 55% (w/w) of LLDPE, and 0% to 5% (w/w) of at least one additive; and an inner polyethylene layer;
a middle barrier layer;
a first tie layer binding the outer printing layer and the middle barrier layer;
an inner sealant layer made up of a multilayered film comprising: an outer polyethylene layer; a core layer comprising 40% to 49% (w/w) of polypropylene homopolymer, 51% to 55% (w/w) of LLDPE, and 0% to 5% (w/w) of at least one additive; and an inner polyethylene layer; and
a second tie layer binding the inner sealant layer and the middle barrier layer.

14. The laminate as claimed in claim 7, wherein the laminate has a thickness in the range of 175 microns to 225 microns.

15. A laminate tube made up of a laminate as claimed in claim 7.

16. A laminate tube made up of a laminate as claimed in claim 8,

17. A laminate tube made up of a laminate as claimed in claim 9.

18. A laminate tube made up of a laminate as claimed in claim 10.

19. A laminate tube made up of a laminate as claimed in claim 11.

20. A laminate tube made up of a laminate as claimed in claim 12.
